(19) United States
(12) Patent Application Publication
(10) Pub. No.: US 2007/0298404 A1
(43) Pub. Date: Dec. 27, 2007

(54) INTERACTIVE PRESENTATION SYSTEM AND METHOD

(75) Inventors: Robert E. Amell, Harrisburg, PA (US); Alfred J. Girondi, Mechanicsburg, PA (US)

Correspondence Address: DUANE MORRIS, LLP;IP DEPARTMENT, 30 SOUTH 17TH STREET, PHILADELPHIA, PA, 19103-4196, US

(73) Assignee: TRAINING MASTERS, INC., Enola, PA (US)

(21) Appl. No.: 11/760,126

(22) Filed: Jun. 8, 2007

Related U.S. Application Data
(60) Provisional application No. 60/804,320, filed on Jun. 9, 2006.

(51) Int. Cl. G09B 3/00

(52) U.S. Cl. 434/350

(57) ABSTRACT

A method of presenting an interactive presentation on a display to an audience includes the step of displaying a slide from a presentation to the audience with a presentation software application, the slide including a selectable element for initiating an audience response session. Upon selection of the selectable element, the audience response session is initiated, wherein the initiating step includes calling a response session screen generator program and passing at least one data element to the response session screen generator program. During the audience response session, question is displayed to the audience and responses are received to the question from a plurality of remote response units distributed to the audience.

### CROSS-REFERENCE TO RELATED APPLICATIONS

This application claims priority to U.S. Provisional Patent Application No. 60/804,320 filed Jun. 9, 2006, entitled “Interactive Presentation System and Method,” the entirety of which is hereby incorporated by reference herein.

### FIELD OF THE INVENTION

The present invention relates generally to communication systems and methods and more particularly to interactive communication systems and methods for education.

### BACKGROUND OF THE INVENTION

Presentation software products are widely used today in both business and academic settings. Perhaps the most common presentation software product is Microsoft's POWERPOINT® software available from Microsoft Corporation of Redman, Wash. As presently configured, POWERPOINT® does not allow for or promote direct audience interaction with the presentation.

U.S. Pat. No. 6,895,213 to Ward, entitled “System and Method for Communicating with Students in an Education Environment,” discloses a system for administering examinations to students.

Improved system and methods for interactive presentations are still desired.

### SUMMARY OF THE INVENTION

A method and system for presenting an interactive presentation on a display to an audience are provided. A slide from a presentation is displayed to the audience with a presentation software application, the slide including a selectable element for initiating an audience response session. Upon selection of the selectable element, the audience response session is initiated, wherein the initiating step includes calling a response session screen generator program and passing at least one data element to the response session screen generator program. During the audience response session, question is displayed to the audience and responses are received to the question from a plurality of remote response units distributed to the audience.

A method and system for preparing an interactive presentation for display to an audience on a display is also provided. A slide within an electronic presentation having a file format for display by a presentation software application is selected. A selectable element is inserted into the selected slide, wherein upon selection of the selectable element at least one data element is provided to a response session screen generator program to initiate an audience response session for receiving responses from a plurality of remote response units to a question.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a schematic block diagram of an exemplary system according to one embodiment of the present invention;

FIGS. 2-2G are screen shots of exemplary graphical interfaces illustrating the operation of the system of FIG. 1;

FIG. 3 is a flow diagram illustrating a method of using the system of FIG. 1 in presenting an interactive presentation;

FIGS. 4A-4E are screen shots illustrating a method of preparing an interactive presentation;

FIG. 5 is a view of a command menu for a presentation software application;

FIGS. 6A-6G are screen shots illustrating another method of preparing an interactive presentation;

FIGS. 7A-7C are screen shots illustrating the creation of a question file; and

FIG. 8 illustrates an exemplary interface showing a first response mode of operating the system of FIG. 1.

### DETAILED DESCRIPTION

Interactive presentation systems and methods are described herein for use in an education environment. As used herein, an “education environment” may be a traditional classroom environment but is not limited thereto. The education environment may also include a meeting, focus group, or any other gathering in which an instructor or moderator seeks responses from the group.

Although the system and method are described herein as being used with the POWERPOINT® software application, this is for illustrative purposes only. The system and method described herein apply equally to and can be configured to be used with other presentations software applications, such as COREL PRESENTATIONS software from Corel Corp. of Ontario, Canada, APPLE KEYNOTE software from Apple Corp. of Cupertino, Calif., or LOTUS FREELANCE software from IBM Corp. of Armonk, N.Y., as will be apparent to those skilled in the art.

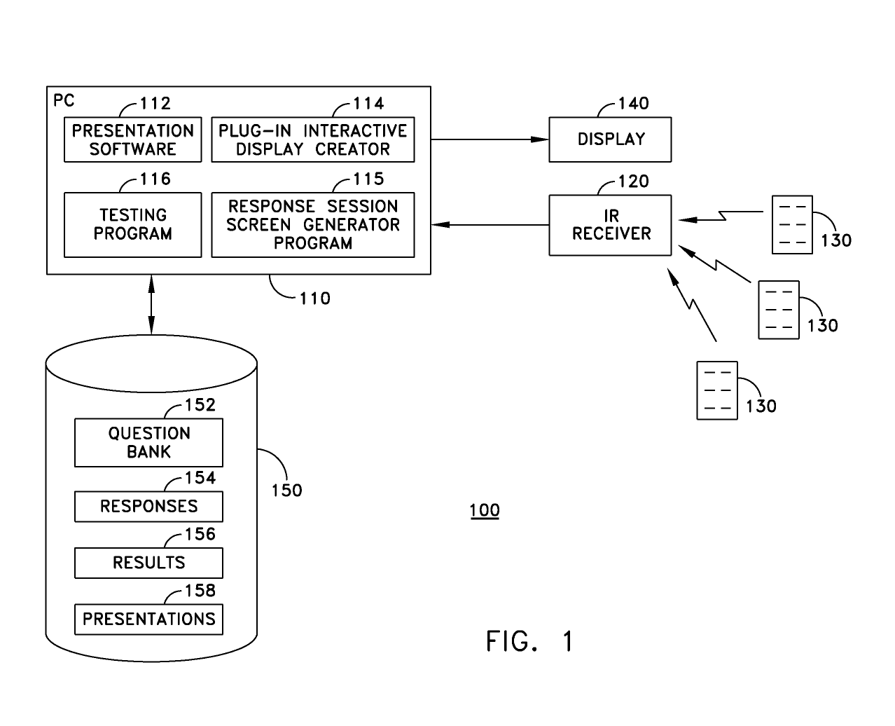

FIG. 1 is a schematic block diagram of an embodiment of a presentation system 100 that allows an audience to actively participate in a presentation by answering questions displayed on a display viewable by the audience. A computer, server and/or other processor runs the operating software for the system. The processor may include microprocessors, microcontrollers, or any other suitable combination of hardware and/or software that processes information and manages components of the system. In a particular embodiment, the processor is the CPU of a personal computer 110 shown in FIG. 1. The processing functions can also be distributed amongst components of the system as will be appreciated by those of ordinary skill in the art.

In one embodiment, the PC 110 is programmed with Presentation Software 112. In one exemplary embodiment, the Presentation Software 112 is a commercial, off-the-shelf software product such as the POWERPOINT® software. In this embodiment, Plug-In Interactive Display Creator software 114 is provided for adding functionality to the Presentation Software 112. As described in more detail below, in some embodiments the Plug-Interactive Display Creator software 114 provides functionality for adding interactive questions to POWERPOINT® presentations. This is accomplished through the development of a POWERPOINT add-in. The add-in is attached to the POWERPOINT® software when the Plug-Interactive Display Creator software 114 described herein is installed. Once attached, every time the POWERPOINT® software is run, a menu corresponding to the added functionality will appear within the standard menu of the POWERPOINT® software. This is accomplished using VBscript. Alternatively, a standalone Testing Program 116 is provided for constructing and displaying interactive presentations independently of or in the absence of the Presentation Software 112. Processor 110 also includes Response Session Screen Generator Program software 115, which is described below in more detail.

The system 100 includes a memory or data storage 150 within or otherwise accessible to the PC 110. The memory may be any type of memory, volatile or nonvolatile, local or remote, suitable for storing information, or combinations thereof. The memory may include magnetic media, optical media, CD-ROMs, DVD-ROMs, local hard drive, removable media or any other suitable form of storage. In some embodiments, memory 150 includes data sets labeled Question Banks 152, Responses 154, Results 156 and Presentations 158.

An infrared (IR) receiver 120 is coupled to an input port, such as a USB port, of the PC 110. The IR receiver 120 receives message signals from a plurality of remote response units 130 distributed to an audience. The message signals contain transmitted data for processing by the PC 110.

The PC 110 is coupled to one or more displays 140 for presenting visual/graphical images to the audience (e.g., POWERPOINT® slides). The display 140 may be a projector, monitor (or collection of projectors or monitors) or other display(s) that will be familiar to those in the art for displaying the presentation slides to the audience and question screens under control of a presenter. As will be familiar to those in the art, a separate display (not shown), e.g., the monitor coupled to PC 110, may also be provided for display of the presentation to the presenter or instructor for use in controlling the display presented on display 140 to the audience.

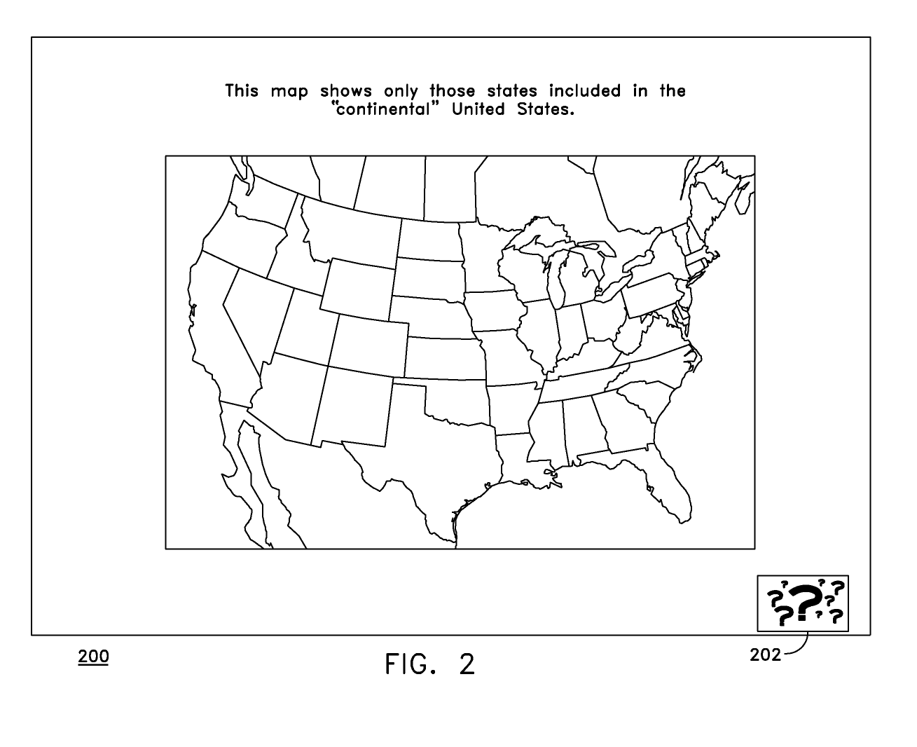

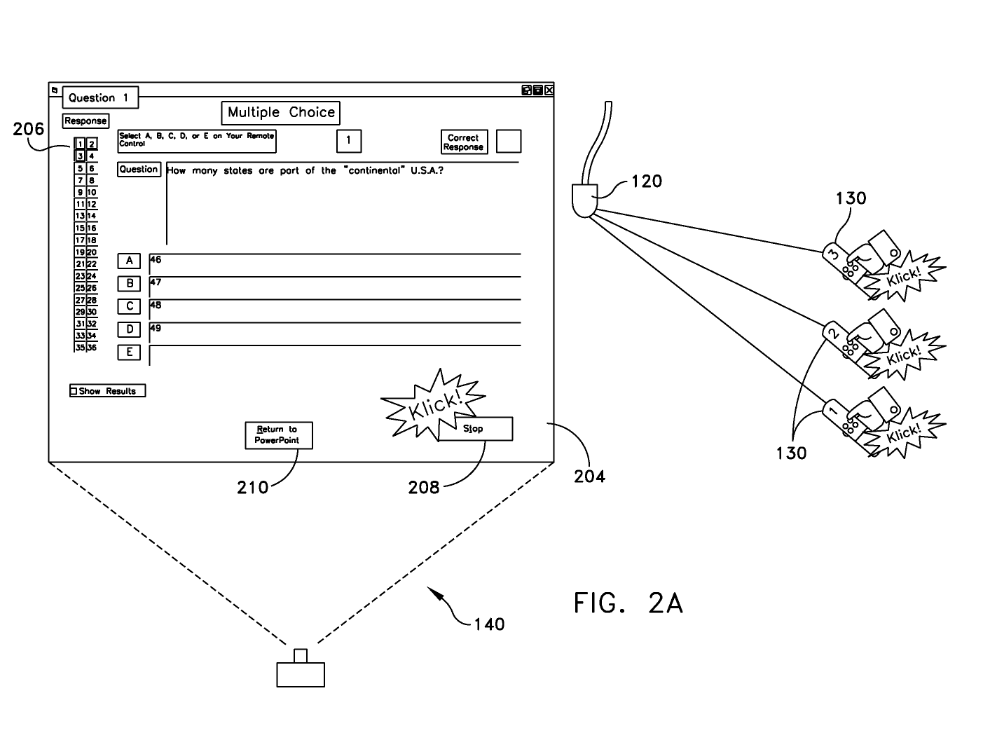

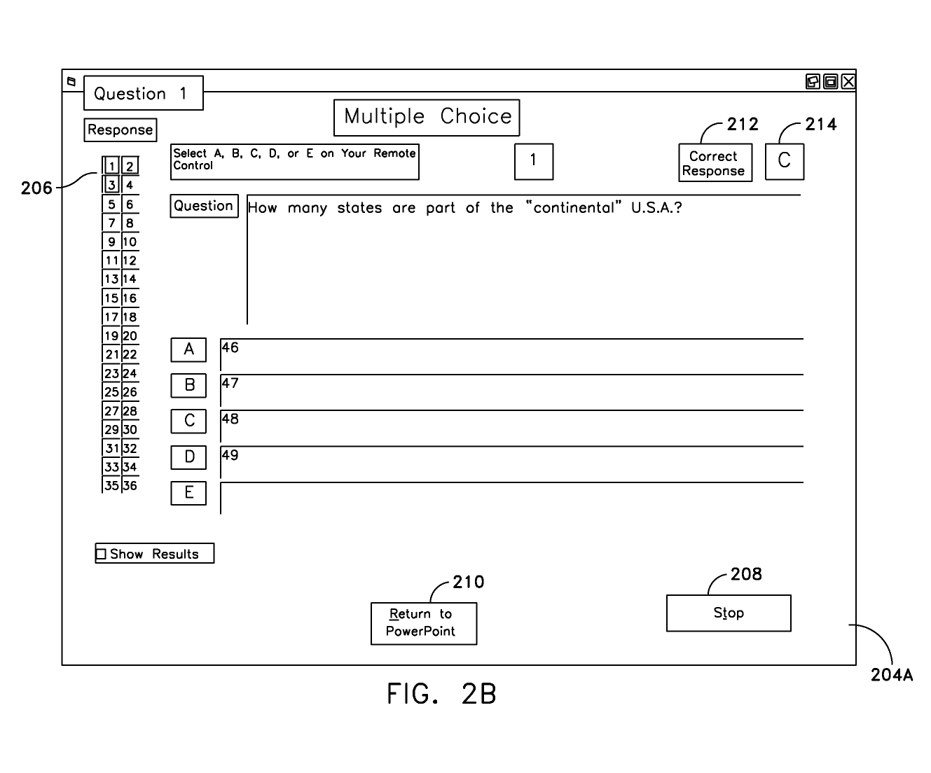

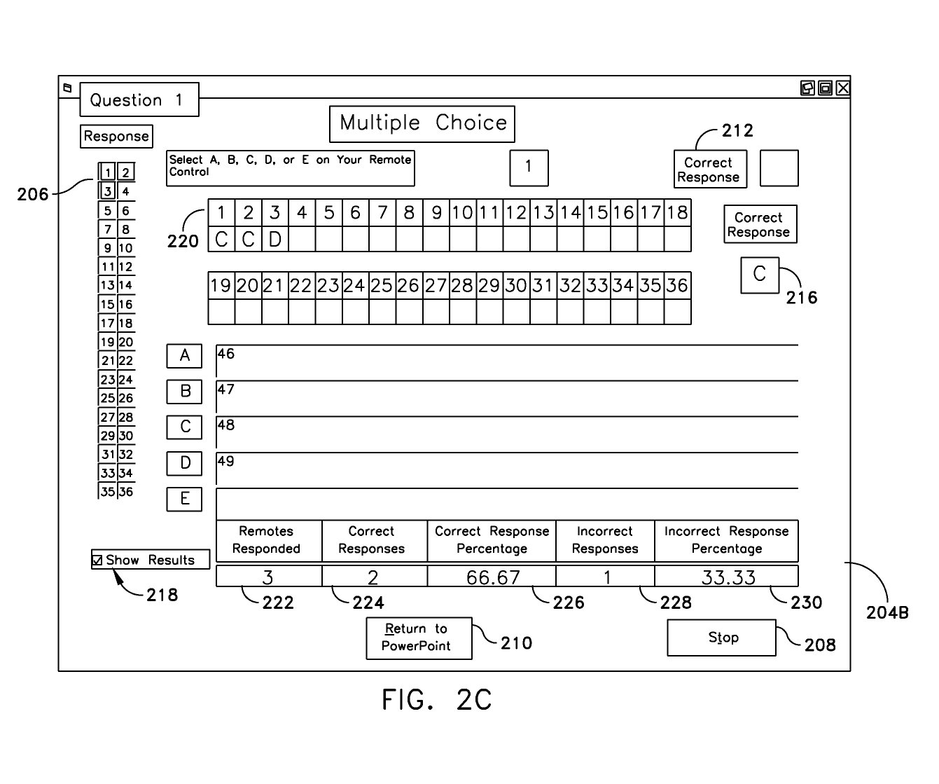

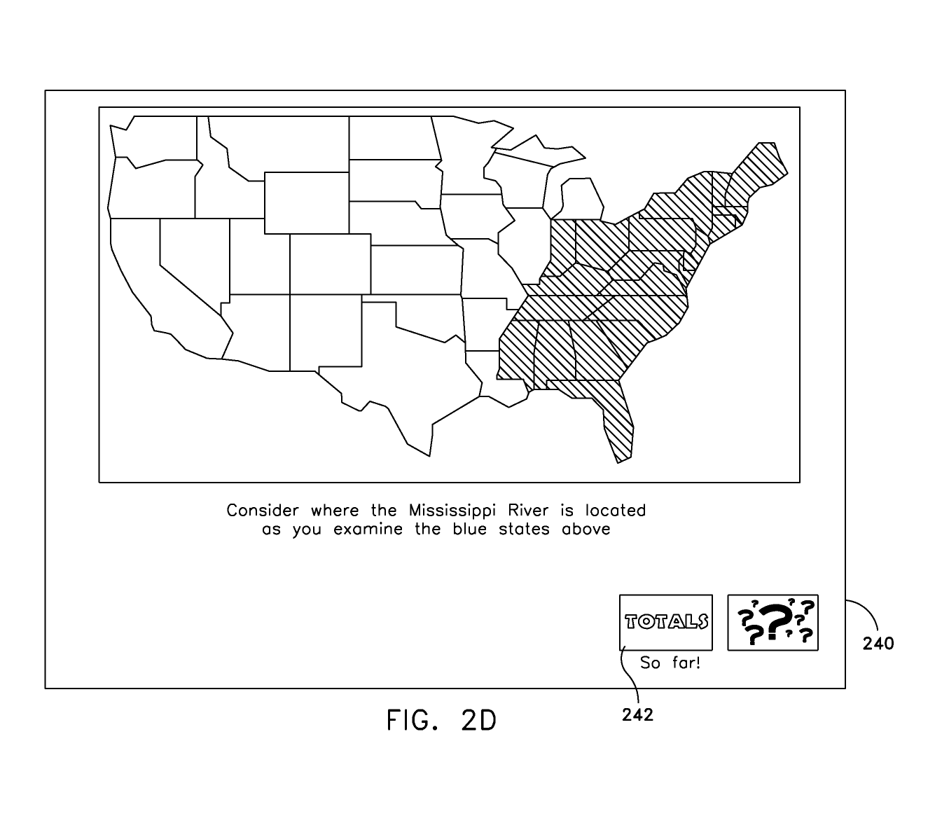

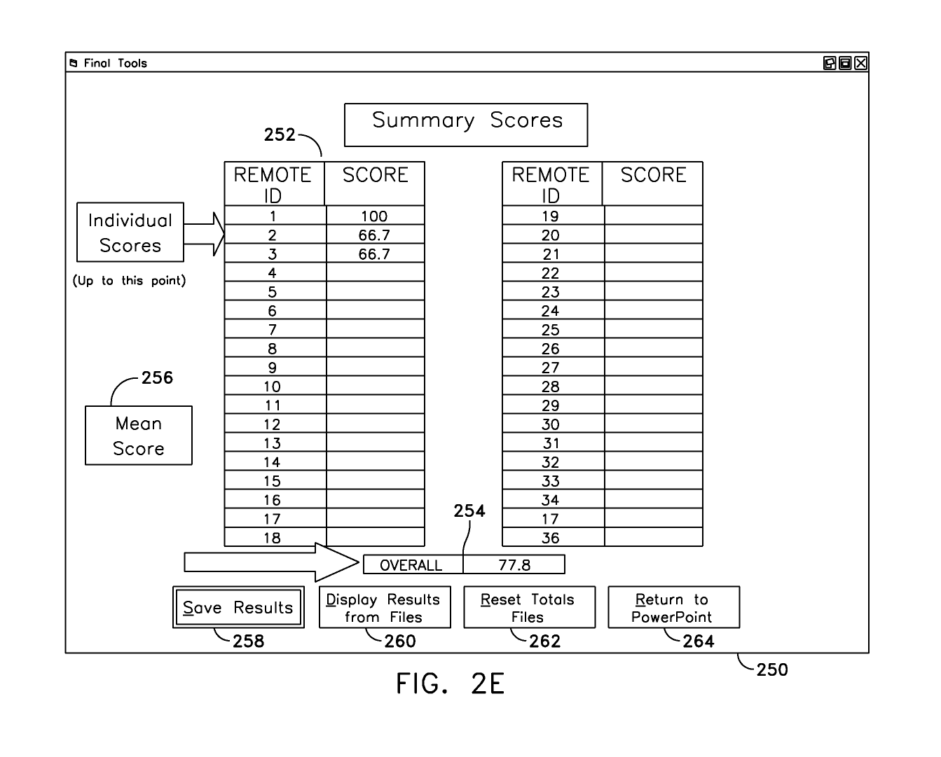

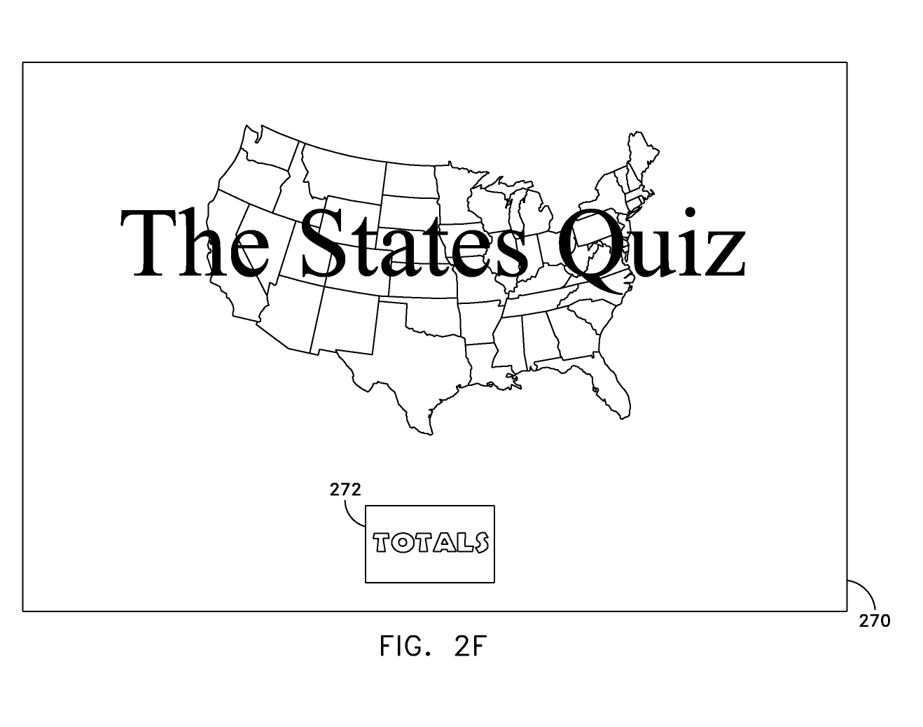

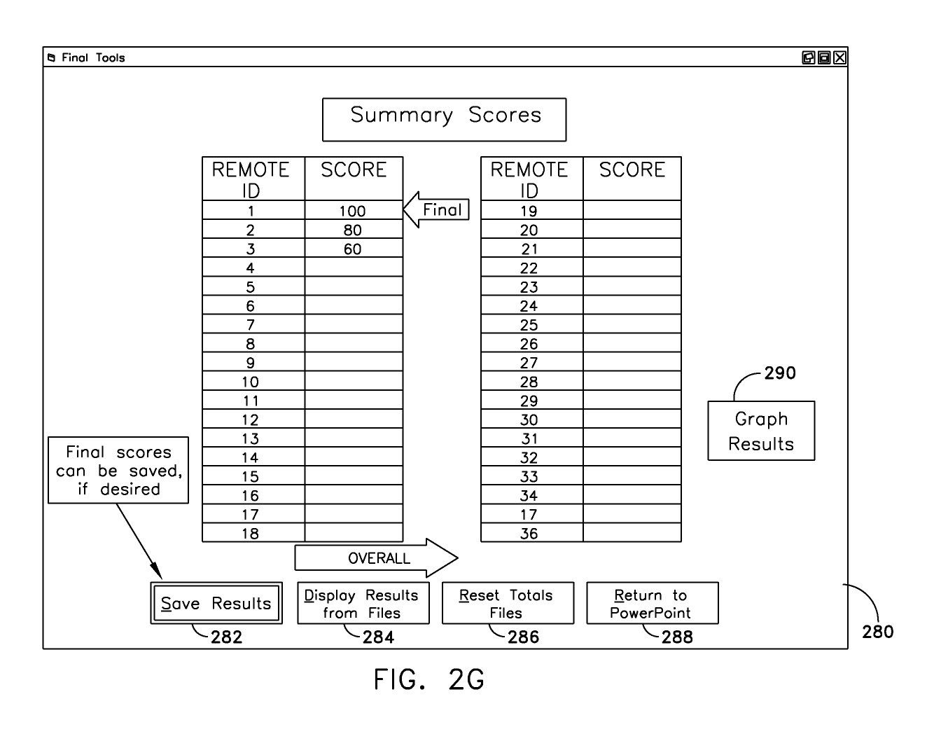

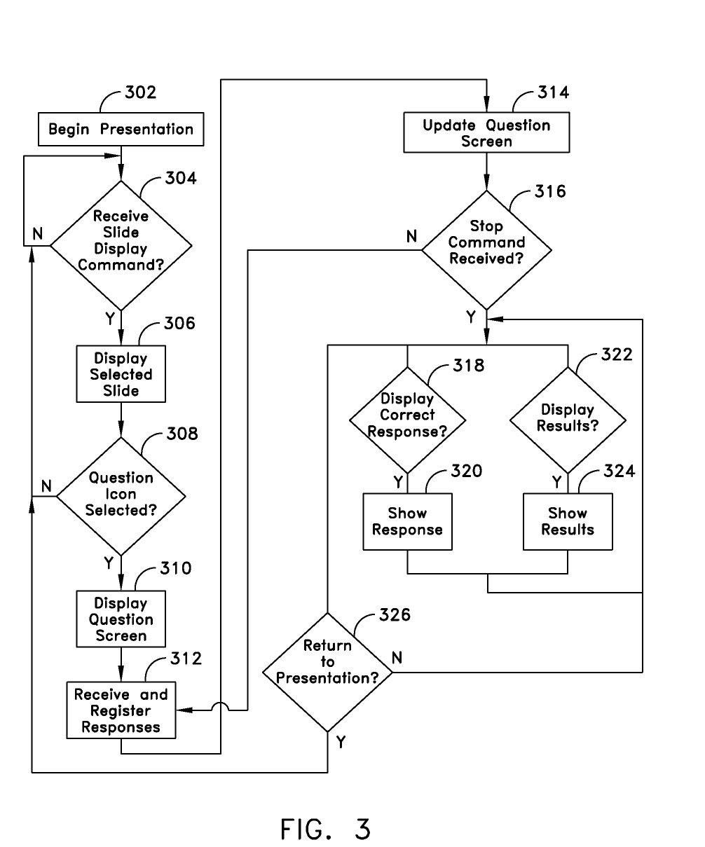

A first method of displaying an interactive presentation using the system of FIG. 1 is explained in connection with the screen shots of various slides of a presentation shown in FIGS. 2-2G and the flow chart of FIG. 3. At step 302, the display of a presentation from stored Presentations 158 is started using PC 110. In an exemplary embodiment, the presentation has the POWERPOINT® presentation file format (.ppt) which is executed by Presentation Software 112 (i.e., POWERPOINT® Presentation Software). The presentation includes a number of slides, at least some of which are interactive as described hereafter. By “interactive”, it is meant that the slide is used to launch an Audience Response Session during which the audience submits responses to a displayed question. The presentation is displayed on or by display 140 to an audience in an educational environment, e.g., a class of students. The audience is provided with handheld remote response units 130 that communicate with the PC 110 via the receiver 120 connected to one of the computer's communication ports. Those of ordinary skill will understand that other forms of communication methods, wired or wireless, can be used to transmit responses from remote response units 130 to PC 110 and the present invention is not limited to any particular transmission method.

As is common, at step 304, PC 110 receives a command from the user to display a selected slide from the presentation for display to the audience. This identification could be of the first slide in the presentation or any other slide thereof selected by the user. The PC 110 then displays the selected slide at step 306. An example of such a slide 200 is show in FIG. 2.

The slide 200 includes whatever content the presenter wants to display to the audience. In this illustrated example, the slide 200 identifies what states are within the “continental” United States. Such a slide may be presented, for example, as part of a remedial presentation on U.S. geography. As can be seen from FIG. 2, the slide is made interactive by inclusion of a selectable element, such as a button or icon 202 labeled with a “?”. Any number of labels for this icon 202 may be used and the illustration of a question mark for the icon 202 is not intended to be limiting in any way. Also, other selectable means may be used instead of a selectable icon 202, such as drop down menus, selectable text or pictures, and the like.

At step 308, the presenter selects the question icon 202, such as by clicking on the icon 202 using a mouse or other user interface device coupled to the PC 110. In an exemplary embodiment, the button 202 has embedded script that calls an external Response Session Screen Generator Program 115. In this embodiment, the script provides the identity of a question from a question file to the Response Session Screen Generator Program 115, which then launches and retrieves the identified question for display in a question screen on display 140 during an Audience Response Session. It should be noted that the external Response Session Screen Generator Program 115 produces and displays the question screen, not the POWERPOINT® software. In embodiments, the button has an embedded VBscript (short for Visual Basic Script) program. In embodiments, the identified question is stored in a question file that is included in Question Bank 152.

At step 310, the Response Session Screen Generator Program 115 displays a question screen by retrieving the question from the question file identified by the button 202. FIG. 2A shows a display 140 presenting an interactive question screen 204 that is produced by the Response Session Screen Generator Program 115. The question screen presents the question “How many states are part of the ‘continental’ U.S.A.?” to the audience that is included in the question file. The question is predefined and relevant to, for example, the previously displayed subject matter of slide 200. The question screen 204 presents the question as a multiple choice question with possible answers being A(46), B(47), C(48) or D(49), which prompts the audience members to answer the question using their respective remote response units 130.

As can also be seen in FIG. 2A, the audience members, shown as members 1, 2 and 3, provide their response to the question by selecting the appropriate button or other indicator on their respective remote response unit 130 that corresponds to their selected answer. The remote unit 130 transmits by infrared carrier a message containing a unique identifier for the unit and the answer selected by the audience member. Each answer is received at the IR receiver 120 and registered by Response Session Screen Generator Program 115 resident at the PC 110 (step 312). Individual audience members may be assigned to, i.e., associated with, a respective remote response unit 130 either before or after the presentation. The association is accomplished by either providing the respondent with a remote with a fixed remote number or by registering the user with a remote with a unique serial number. As responses are received, the Response Session Screen Generator Program 115 updates the question screen 204 to reflect the status of responses received from the audience (step 314). More specifically, visual indications of the responses can be shown in the status grid 206. The grid 206 includes a grid location corresponding to each of the remote response units 130. For example, the grid location “1” corresponds to the first remote response unit. This grid location flashes a first color, such as green, for a short, fixed time when a response is received and then remains green. If the user submits a second response, such as to change or even reconfirm his or her answer afterwards, the grid number flashes a second color, such as red, to show that the user is again submitting an answer. Thereafter, the grid sector returns to the green color.

It should be understood that other visual indicators besides color could be used, such as textual or other indications shown in the grid 206. Also, use of a grid 206 is not required. Rather, other means of visually tracking the status of responses may be utilized, such as lists, charts, tables and the like.

The presenter monitors the receipt of responses by viewing the response activity as reflected in the status grid 206. Once the presenter is satisfied that a sufficient number, or all, of the audience members have responded and new responses are not being received, or sufficient time has passed, the presenter selects the “Stop” icon 208 (step 316). This selection causes the Question Slide Generator Program 115 to stop accepting responses from remote response units 130 and to, optionally, update the total score of each participant to that point.

As shown in display 204A of FIG. 2B, after the presenter selects the “Stop” icon 208 at step 316, the presenter can then elect to select the “Correct Response” icon 212 (step 318), which instructs the Response Session Screen Generator Program 115 to display the correct response. In this embodiment, the correct response is identified in the question file accessed by the Response Session Screen Generator Program 115. In this example, the correct response data reflects a correct answer of “C”, which is displayed in location 214.

Alternatively, or thereafter, at step 322, the presenter elects to display the individual responses received from respective audience members. With reference to display 204B of FIG. 2C, this action is selected by clicking on the “Show Results” button 218. This button is a toggle button, so selecting a second time causes the results window to disappear. As seen in FIG. 2C, the responses of the audience as well as other information are displayed in display 204B at step 324. The display 204B shows the correct response in window 216 and the respective responses received from the individual audience members in location 220. Other information can be tallied by the Response Session Screen Generator Program 115 and displayed in the display 204B, such as response statistics including the number of responses received (222), the number of correct responses received (224), the correct response percentage (226), the number of incorrect responses 228 and/or the incorrect response percentage (230).

During the display of any of the screens of displays 204, 204A, 204B, the presenter can elect to return to the presentation by selecting, at step 326, the “Return to PowerPoint” icon 210. This selection causes the Response Session Screen Generator Program 115 to terminate its display and control to return to the Presentation Software 112, i.e., the display 140 returns to the display of the slide from which the Response Session Screen Generator Program 115 was called at step 308 (i.e., the slide 200 from which the user selected the icon 202).

As shown in the displayed slide 240 of FIG. 2D, an interactive slide may also include a “Totals” button or icon 242. If the slide 240 is not the last interactive slide, selection of the Totals button 242 again calls the Response Session Screen Generator Program 115, which presents the results to that point that are stored in a results tracking file. For example, one results tracking file can be updated with the results of each interaction. Even after the presentation software, the results tracking file remains, keeping the last set of results. The presenter decides when to save the results to a separate file or to clear them from the results tracking file. The Response Session Screen Generator Program calculates and displays the score of each individual audience member to that point based on the received, registered responses to that point. For example, FIG. 2E shows an example of a screen 250 displayed after selection of the Totals icon 242 from FIG. 2D. In one embodiment, a table 252 is displayed showing the score to that point for each audience member. Table 252 shows that the audience member with the Remote Response Unit No. 1 has a perfect score, whereas the audience members who are using Remote Response Unit Nos. 2 and 3 have answered correctly 66.7% of the questions to that point. A mean score can be calculated and displayed at “Overall” window 254 by selecting “Mean Score” button 256 or automatically displayed.

Other options are also available from screen 250. Button 258 may be selected to cause the Question Slide Generator Program 115 to save the results displayed in screen 250 and/or the underlying data to a local drive. As described above, selection of “Return to PowerPoint” icon 264 returns the display to the slide 240 from which Question Slide Generator Program 115 was called. Selecting Reset Totals Files 262 resets all summary scores to zero. The effect of this is seen the next time scores are displayed. This is useful if you are at the end of your presentation, and no longer need the results. The scores can also be reset from the embedded menu system. Finally, selecting Display Results from Files option 284 allows the recall and display of any stored score file. This is useful for keeping records of interactions on your computer.

FIG. 2F shows an example of the final slide 270 of a presentation (e.g., a POWERPOINT® presentation), or a slide that is displayed after all of the interactive question screens in a given presentation have already been presented. This slide 270 also includes a “Totals” button 272, which when selected calls the Response Session Screen Generator Program 115 which then displays the final, cumulated totals for the responses received from the audience during the presentation. FIG. 2G shows an example of a screen 280 that is displayed using the Totals button 272 of FIG. 2F. As can be seen from the slide 280, the first audience member answered all of the presented questions correctly. The second and third audience members answered 80% and 60% of the presented questions correctly, respectively.

As discussed above, this screen 280 may also present other options to the presenter, which are represented by selectable icons, including Save Results 282, Display Results from Files 284, Reset Totals Files 286 and Return to PowerPoint 288. Selecting Graph Results button 290 causes the results to be presented in graphical form, such as in a bar chart or other graphical representations. Selecting the Return to PowerPoint button 288 causes the display to return to the POWERPOINT® slide from which the user selected the Totals button. Selecting Reset Totals Files 286 resets all summary scores to zero when the Totals screen is closed. The effect of this is seen the next time scores are displayed. This will zero the totals for the next session. Selecting Save Results option 282 saves the numerical totals shown on the Summary Scores screen. If this option is selected, a window opens that allows the user to select the location to which to save the results. Finally, selecting Display Results from Files option 284 allows the recall and display of any stored score file.

As described above, in one embodiment the Response Session Screen Generator Program 115 is a Visual Basic program. In an alternative embodiment, Flash, Director or other GUI languages or scripting utilities may be used as well as remote interaction scripting language or programs such as Adobe Authorware, Visual Basic and IShell.

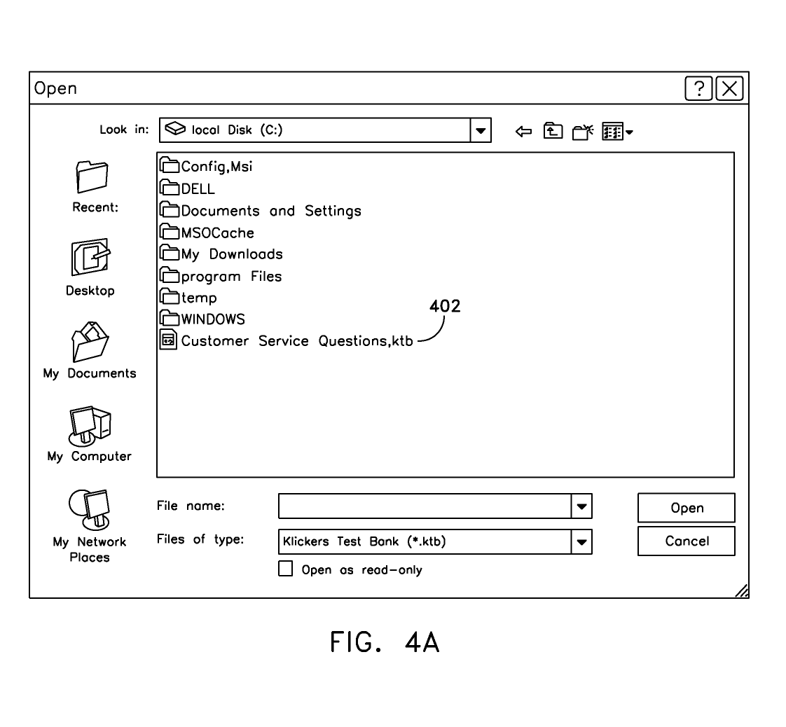

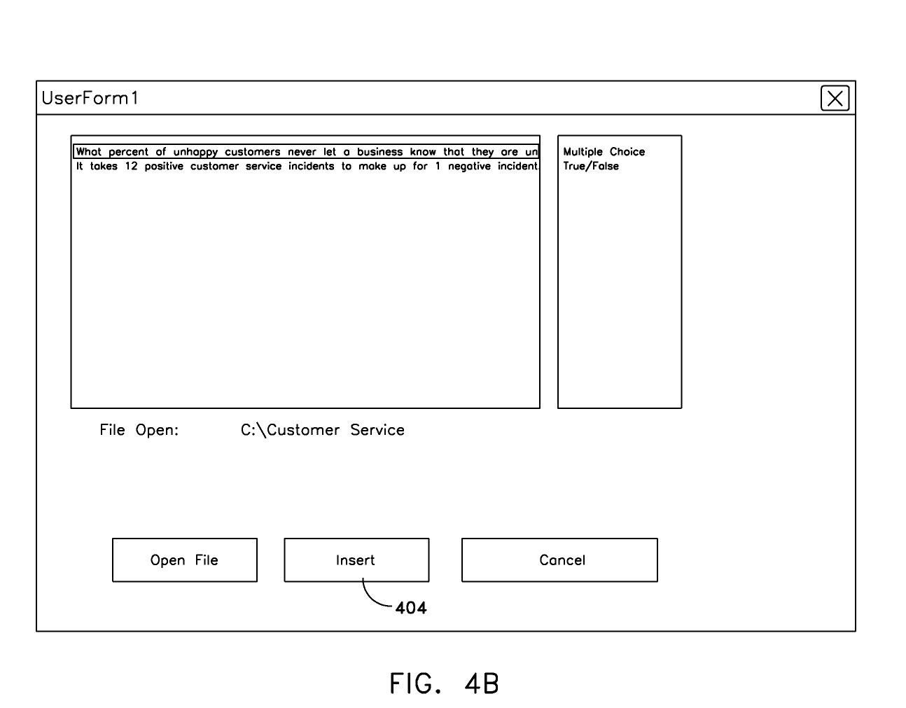

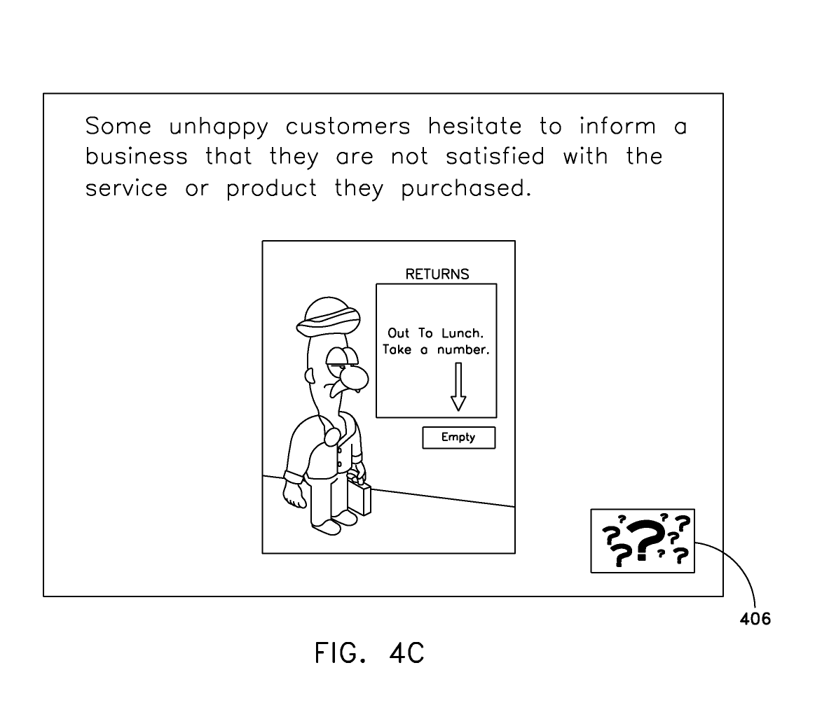

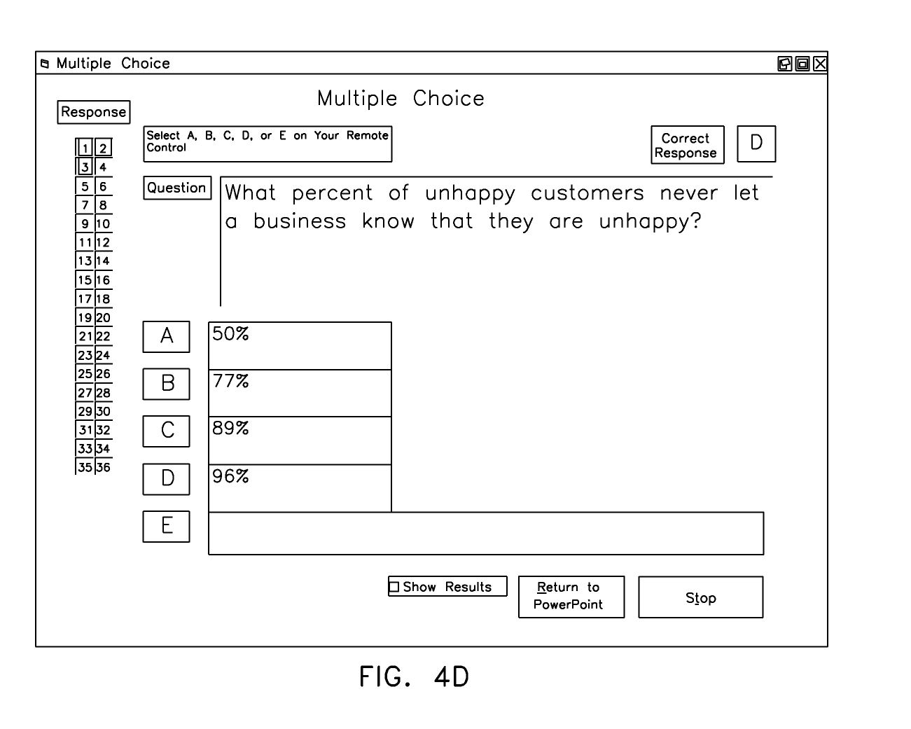

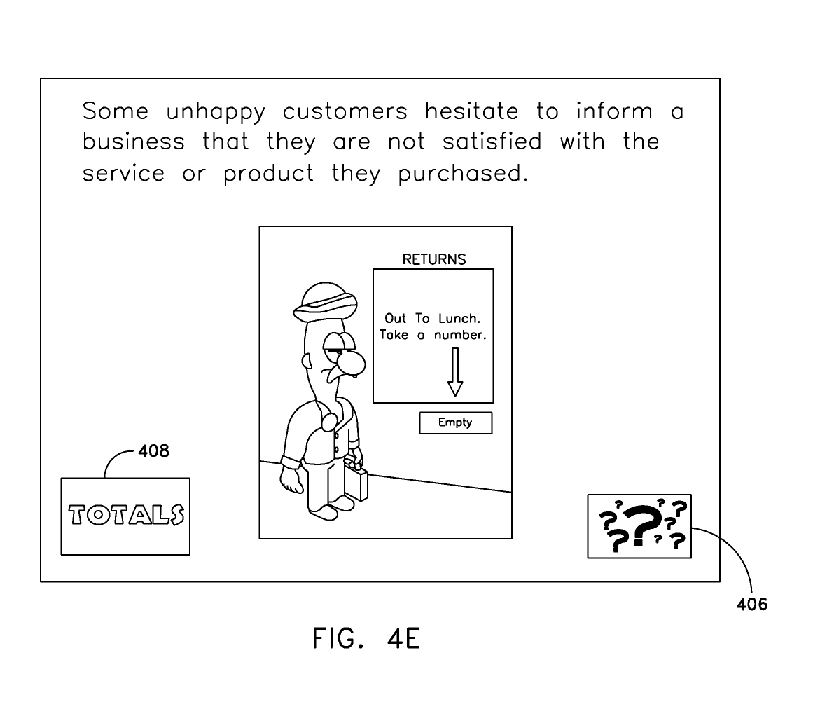

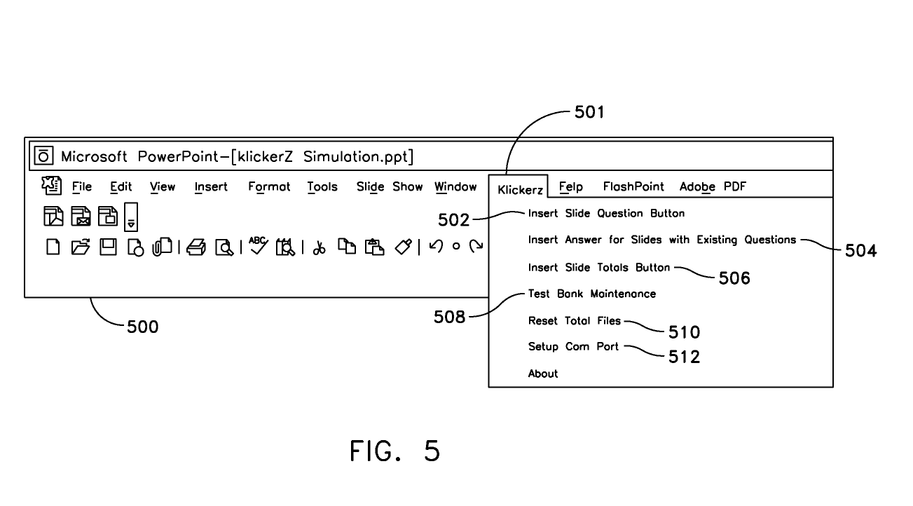

The screen shots of FIGS. 4A-4E and FIG. 5 illustrate a method of preparing an interactive presentation, such as described in connection with FIGS. 2-2G and 3. More specifically, the method is used to create the interactive slides discussed above in connection with FIGS. 2-2G where question screens are generated by Response Session Screen Generator Program 115 from questions that are stored in question files in the question bank 152 from data storage.

FIG. 5 shows a command menu for a standard POWERPOINT® software application with one modification. The command menu has been modified to include a tab 501 identified as “Klickerz” to provide functionality associated with the “Plug-In Interactive Display Creator” software 114. The command menu includes options 502-512, which are discussed below.

Option 502 (“Insert Slide Question Button”) and Option 508 (“Test Bank Maintenance”) are utilized when questions that have already been written and are stored in question files will be used. Using these options, a selectable member (e.g., button 202 of slide 200 of FIG. 2) is created and inserted into a slide, so that when the button is selected, a question screen (e.g. screen 204 of FIG. 2A) is produced and displayed by Response Session Screen Generator Program 115 from a question stored in a question file.

First, using the POWERPOINT® software, a presentation, such as a POWERPOINT® presentation from presentations 158, is opened and a slide is displayed which the user wants to make interactive by insertion of a question button. While the slide is displayed, the user selects option 502 from the drop down menu 501. Selecting option 502 allows the user to search for question files of the type “.ktb” as shown in FIG. 4A. As can be seen from FIG. 4A, a question file 402 called “Customer Service Questions.ktb” is stored on the C: drive of the processor 110. The user can select this file by clicking on it. Clicking on or otherwise selecting the question file opens the file in a display shown in, for example, FIG. 4B. Each question file includes one or more questions. A list of the questions that are stored in the file is displayed along with the “question type” for each question (e.g., Multiple Choice or True/False). As can be seen in FIG. 4B, the file includes two questions. “Clicking” on or otherwise selecting one of the questions selects that question. When the “Insert” button 404 is then selected, the plug-in Interactive Display Creator 114 creates the scripting for a question button and adds the question button to the slide selected by the user, as shown by, for example, the question button 406 inserted in the slide of FIG. 4C. As described above, in this embodiment, the embedded scripting for the question button 406 includes an identifier for the question (e.g., questions number and question file location) and a call to the Response Session Screen Generator Program 115. The following script is an example for button 406, with a description of the function of each code line shown in parenthetical:

Private Sub CommandButton1_Click( ) (this is the start of a button
script)
ActivePresentation.Slides(1).Copy (forces the button window active)
Shell “c:\Program Files\Klickerz PP Add-in\DispQuestion.exe
C:\Documents and Settings\Robert
Amell\Desktop\Final Pearson MA Book\Quizzes\Chp45.ktb 6”
(Starts the interaction and passes the question bank name and the
question number to the called program)
End Sub (ends the button script)

As described above, selecting the question button from FIG. 4C causes Response Session Screen Generator Program 115 to display a question screen (shown in FIG. 4D). The question screen looks like a PowerPoint® slide but it is not. Rather, it is a display screen that is generated outside of the POWERPOINT® software by Response Session Screen Generator Program 115 from the question identified in the question button 406 of FIG. 4C.

A totals button can be inserted into a selected slide using option 506 from plug-in drop down menu 501. Selecting this option adds an interactive Totals button to the selected POWERPOINT® slide. FIG. 4E shows the slide of FIG. 4C having a Totals button 408 added thereto.

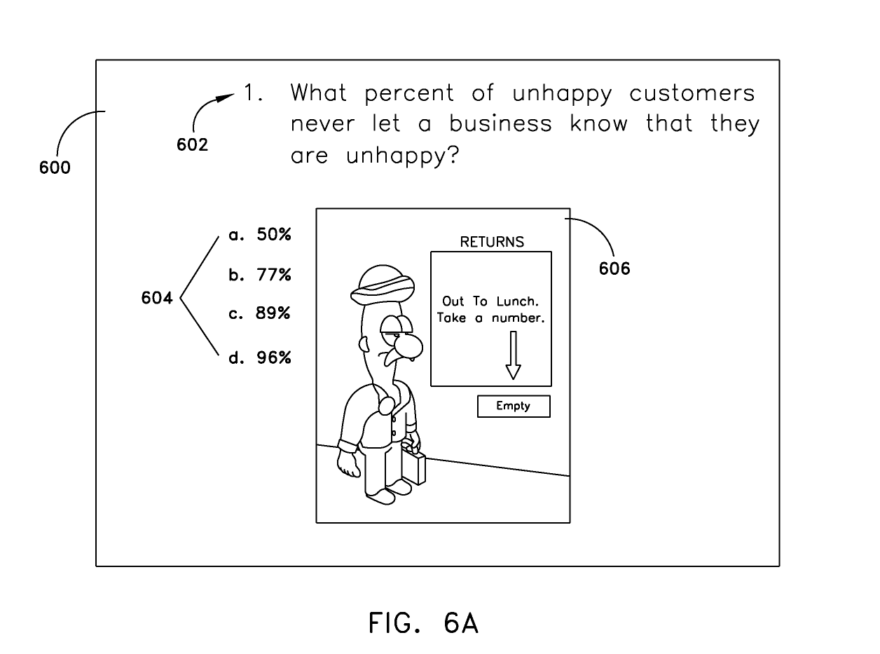

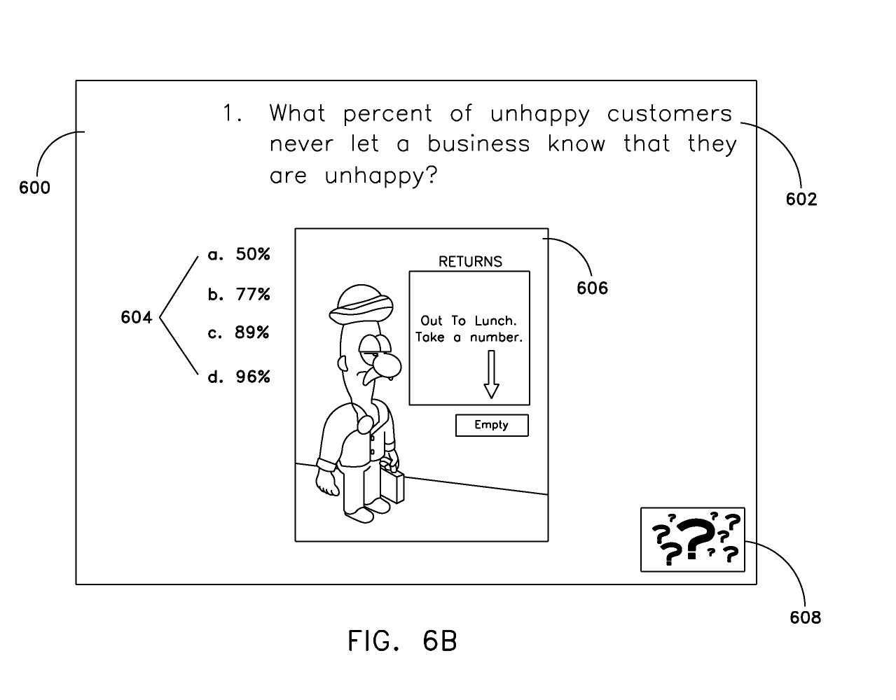

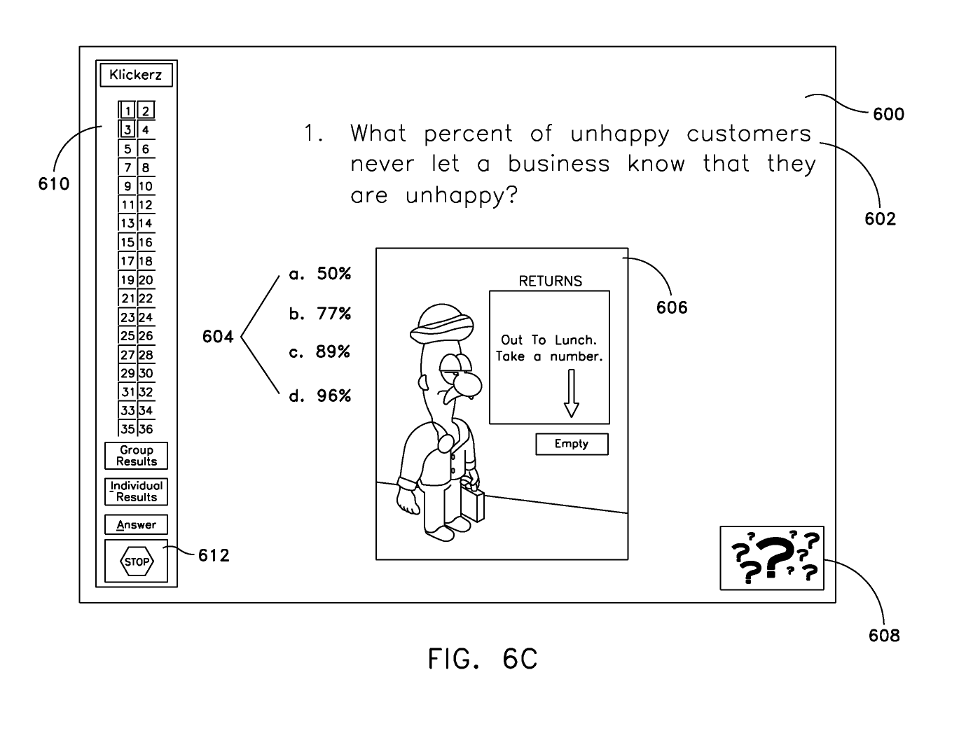

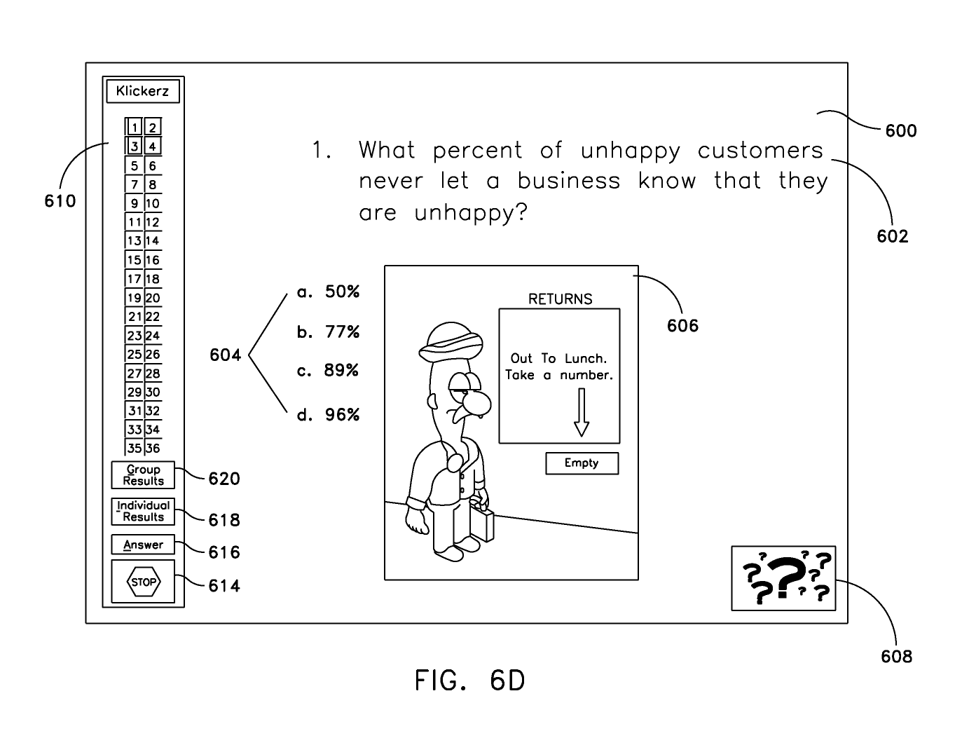

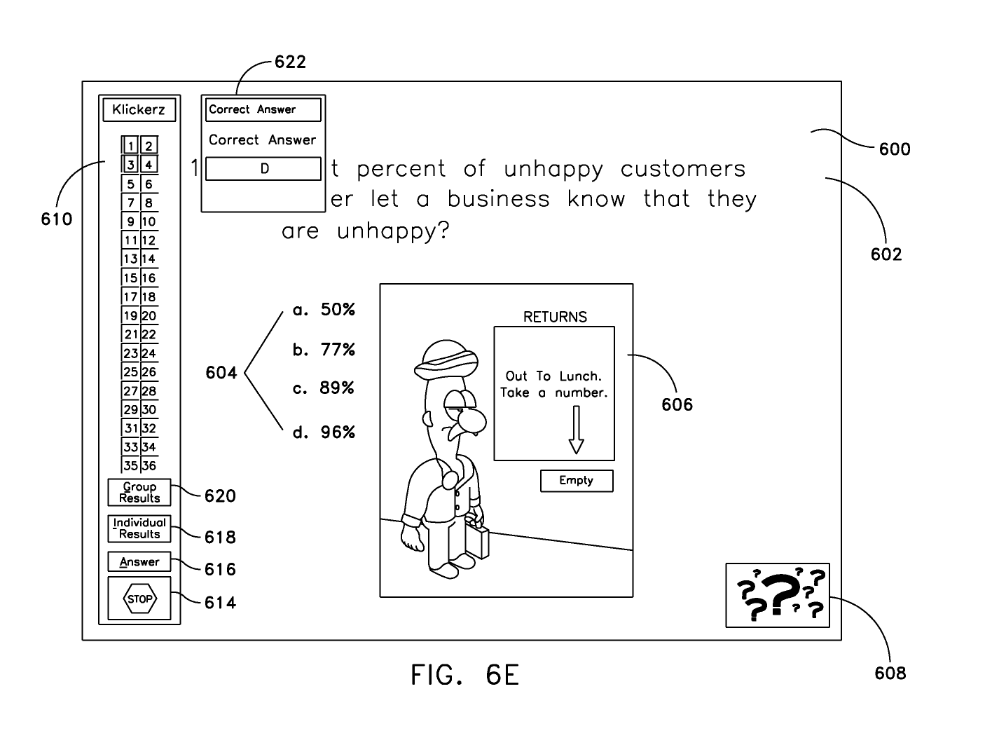

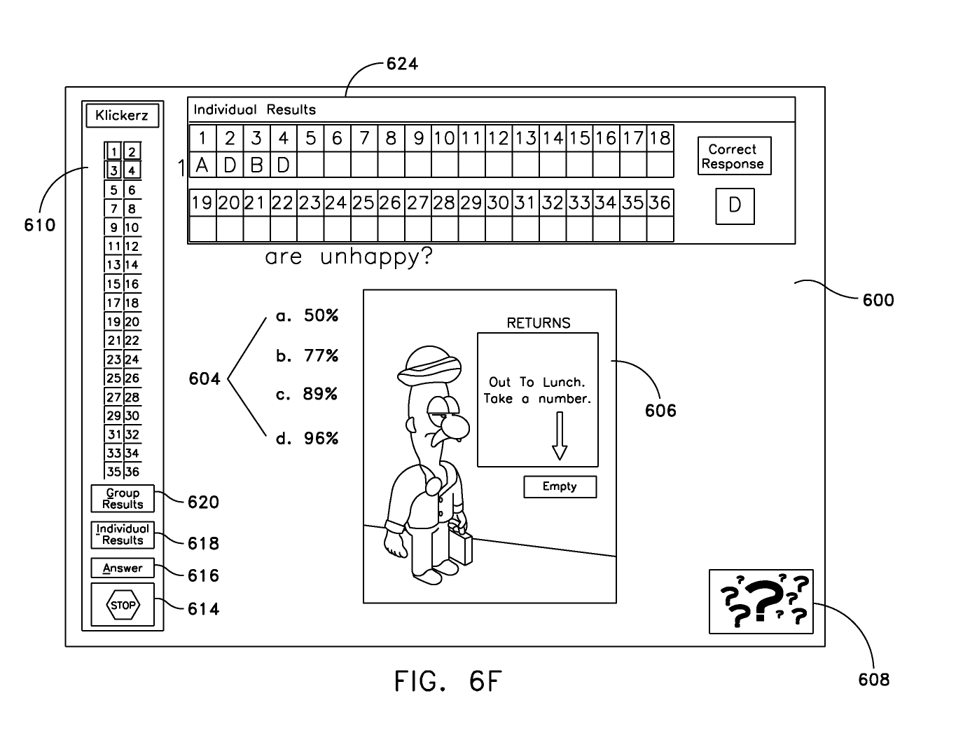

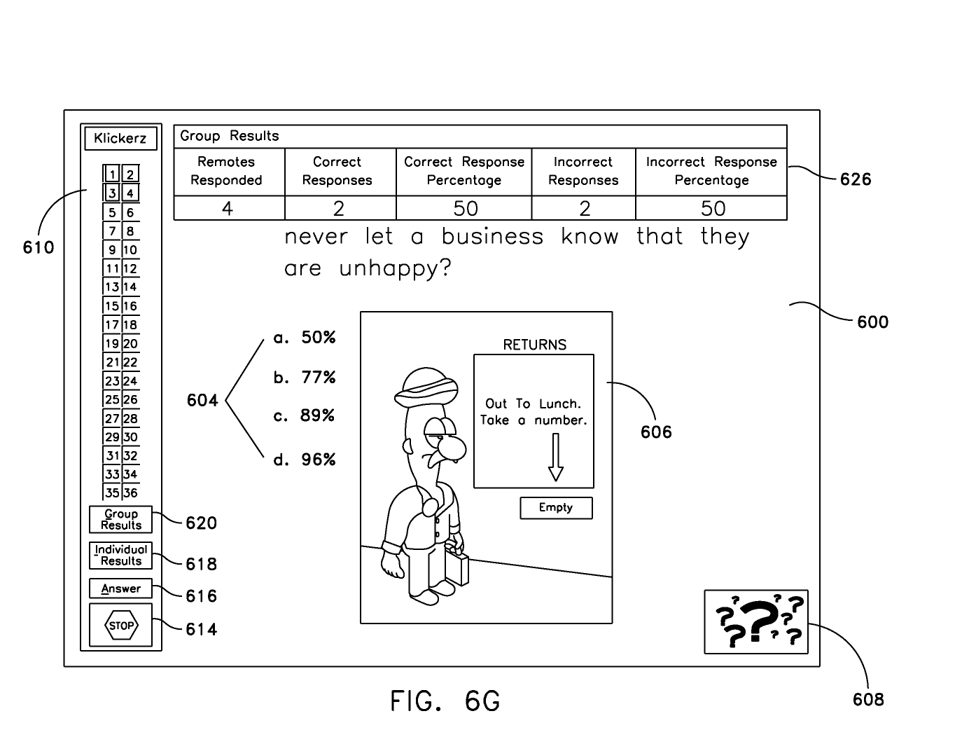

FIGS. 6A-6G illustrate an alternative embodiment for preparing interactive slides using the Plug-In Interactive Display Creator 114. In this method, the questions are displayed within the POWERPOINT® presentation itself, i.e., appear on the POWERPOINT® slides, rather than in a screen created by Response Session Screen Generator Program 115. However, the portions of the interactive screens discussed above for showing the receipt of responses, correct answer, response summaries, etc. are displayed by the Response Session Screen Generator Program 115 as overlays on the POWERPOINT® slide that includes the question.

As shown in FIG. 6A, a user first creates a POWERPOINT® slide in a manner readily familiar to those in the art. For example, the user selects a background 600 and then uses a text field to type a question 602 and possible responses to the question 604. Any graphics 606 deemed desirable can also be added to the slide.

After the content of the slide is created, the user adds an interactive question button 608 (FIG. 6B) to the slide. This is accomplished by selecting option 504 from drop down menu 501. When the option is selected, the software asks the user to identify the correct answer to the question, e.g., “A”, “B”, “C” or “D”, and then the script for the question button is created and the question button is inserted at the bottom right corner of the slide, as shown in FIG. 6B. Like the question button 406 of FIG. 4C, the question button 608 includes embedded script that calls the Response Session Screen Generator Program 115 and provides at least one data element to thereto. However, unlike button 406 of FIG. 4C, the script of the question button 608 does not need to identify a question for display because the questions is already included in the POWERPOINT® slide. Rather, the script passes a data element representing the correct response to the question to the Response Session Screen Generator Program 115. More specifically, the correct response data provided to the Response Session Screen Generator Program 115 is embedded in the call feature of the button 608 and includes “True” or “False” for a true/false question, or “A,” “B,” “C,” “D,” etc. for a multiple choice question. The following script is an example of the script for button 608, with a description of the function of each code line shown in parenthetical:

Private Sub CommandButton1_Click( ) (Starts the button
script)
ActivePresentation.Slides(1).Copy (Forces the current button active)
Shell “c:\Program Files\Klickerz PP Add-in\AnswerBtn.exe 3”
(Calls the interaction program and sends the correct answer to it
(i.e. 3= C))
End Sub (Ends the button script)

During display to the audience, selection of the button 608 causes Response Session Screen Generator Program 115 to display a response grid 610 for an Audience Response Session and command buttons directly over the POWERPOINT® slide, as shown in FIG. 6C. As described above in connection with FIGS. 2A-2C, when a participant presses a button on his remote response unit, his respective section from the response grid 610 will indicate the receipt of a response by changing colors or other visual representation. The presenter knows when all responses are in when the windows of all participants are green. Clicking on the STOP button 612 ends the response period. The STOP button is then replaced with an EXIT button 614 and the other control buttons 616, 618, 620 become active (i.e., selectable), as shown in FIG. 6D.

Selecting the ANSWER button 616 causes the Response Session Screen Generator Program 115 to display the Correct Answer, as shown in overlay window 622 of FIG. 6E. As shown in FIG. 6F, selecting the Individual Response button 618 causes display over the slide of an individual response grid or table 624 overlaid on the POWERPOINT® slide, which shows the individual responses received for the question from the remote response units 130. Finally, selecting the “Group Results” button 620 causes display of the group response statistics in an overlay window 626, as shown in FIG. 6G. Selecting the EXIT button 614 terminates the display of overlays by the Response Session Screen Generator Program 115, leaving only the original POWERPOINT® slide from FIG. 6B displayed.

One advantage to presenting the question directly in a POWERPOINT® slide as detailed in FIG. 5 and FIGS. 6A-6G is the ease by which interactive slides can be created. The method can be used when creating POWERPOINT® slides or with slides from an existing, already created POWERPOINT® presentation. Further, the interactive button need only transmit correct response data to the Response Session Screen Generator Program 115. It does not need to identify a question in a local storage for use by the Program 115.

With the creation method illustrated by FIGS. 4A-4E, however, questions are stored apart from the POWERPOINT® presentation file in separate question files that can be created and edited outside of POWERPOINT® software. Banks of questions can be created and archived for later use. Questions can also be deleted and added to individual question files. These questions are also available for use with the testing and game programs discussed below. However, the location of the questions file should not be changed. If the location of a question file is changed after insertion of the interactive button, the call to the Response Session Screen Generator Program 115 will not be accurate because the location of the question is programmed into the button. If the files or locations are changed, the interactive question button can be deleted from the slide that calls the question and a new button added using the method of inserting a button described above. The newly added button will point to the new location of the question or question file.

Returning to the modified POWERPOINT® menu 500 of FIG., the fifth option 510 (“Reset Total Files) and sixth option 512 (“Setup Com Port”) from menu 501 are used when it is time to present an interactive program to an audience that was developed using either the methods of FIGS. 4A-4E or FIGS. 6A-6F described above. Before starting a presentation, the Reset Totals Files option 510 should be selected to clear any leftover score data from previous presentations. Also, after connecting the infrared receiver to the PC 110, the Setup Corn Port option 512 is selected. The PC 110 will then provide a notification when the correct USB port is found. The receiver is located by searching each USB port, looking for a unique identifier that the receiver transmits when a special code is sent to it. This step does not need to be repeated as long as the receiver remains connected to the computer 110.

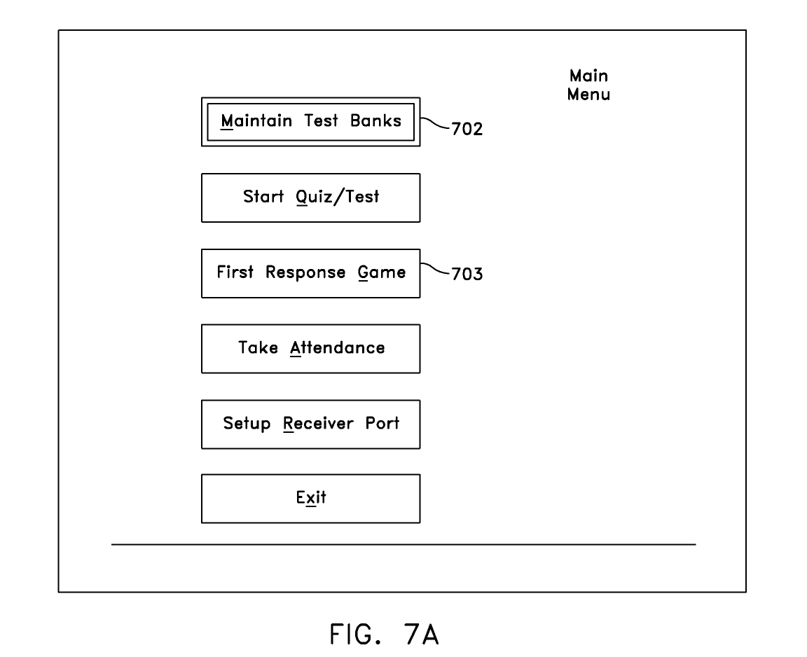

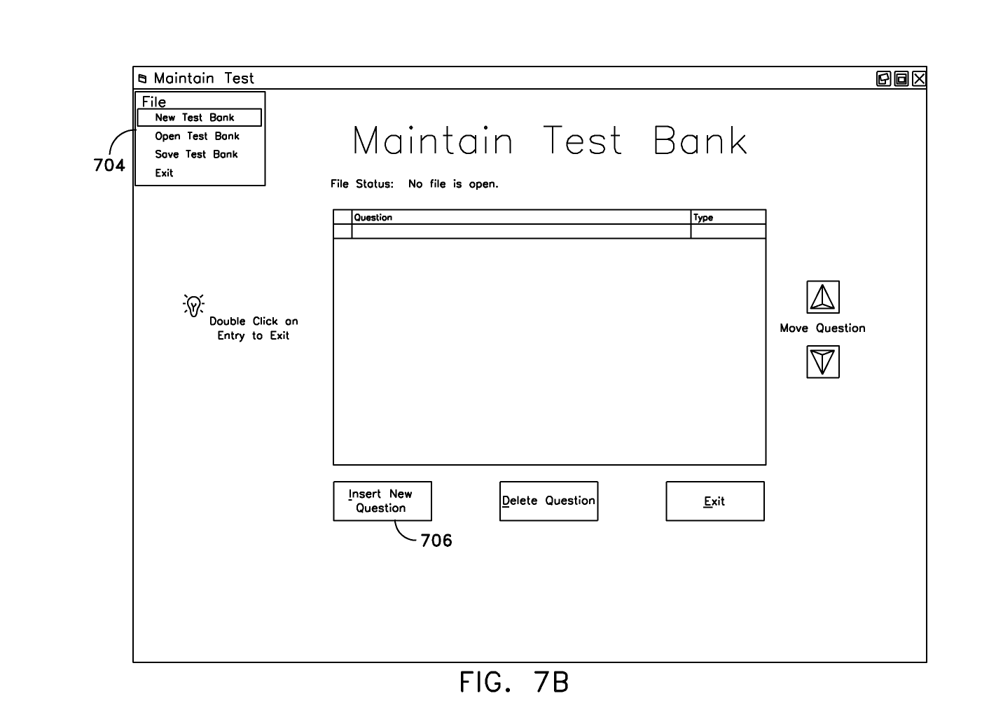

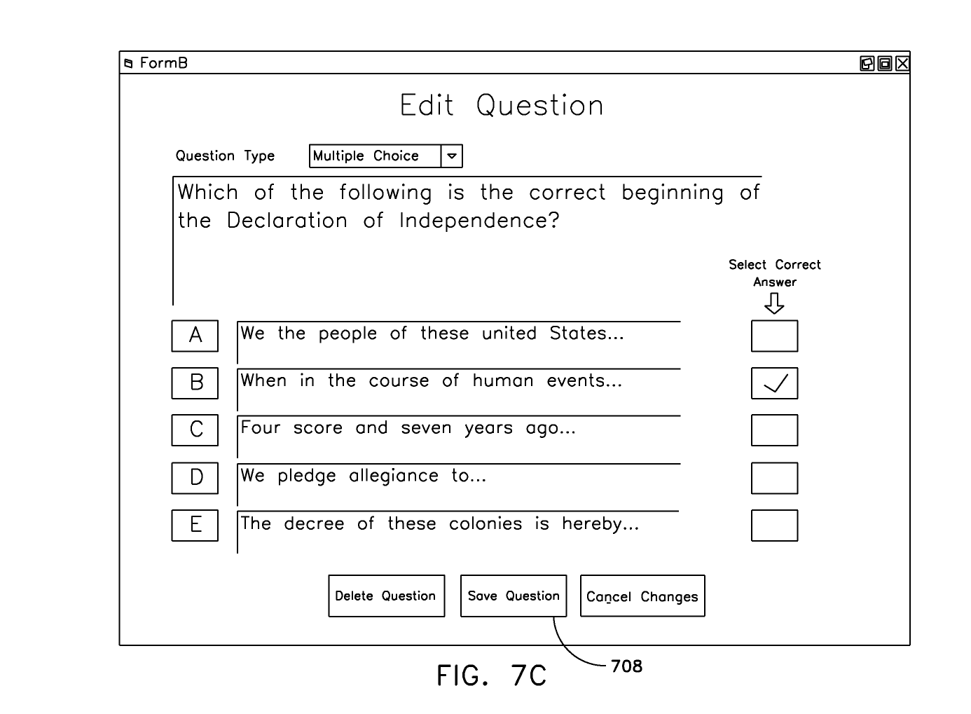

Option 508 allows the user to maintain the questions stored in the test bank. Also, new test banks can be created using this option. This option is discussed in more detail below in connection with the description of option 702 of FIG. 7A.

FIGS. 7A-7C illustrate a method of creating question files (e.g., Question File 402 of FIG. 4A) using the Testing Program 116. The Testing Program can be used to construct interactive “stand alone” quizzes that operate independently of POWERPOINT® or to construct a question file for use in creating interactive question buttons for insertion in presentation slides using Plug-In Interactive Display Creator 114 and for use in creating questions screens with Response Session Screen Generator Program 115. FIG. 7A is a screen shot of an exemplary main menu screen for the Testing Program 116. When the user selects the Maintain Test Banks option 702 the interface of FIG. 7B is displayed. Menu option 704 gives the user the option of creating a new test bank (i.e. question file), opening an existing test bank or saving a test bank. If the user selects “new test bank” a window opens (not shown) that allows the user to name the question file and determine a storage location for the new file. Selecting the Insert New Question button 706 opens an Edit Question screen, which allows the user to compose a question for the new question file.

An Edit Question screen is shown in FIG. 7C through which the user can add questions and possible responses, as well as designate the correct answer. The default “question type” is “multiple choice” but “True/False” question type can also be selected. The question is saved to the file by selecting the Save Question option 708. Using this methodology, the file can be populated with any number of questions for later use. These questions can then be used in creating interactive POWERPOINT® presentations as detailed above in connection with FIGS. 4A-4E or by a standalone software product for presenting a test.

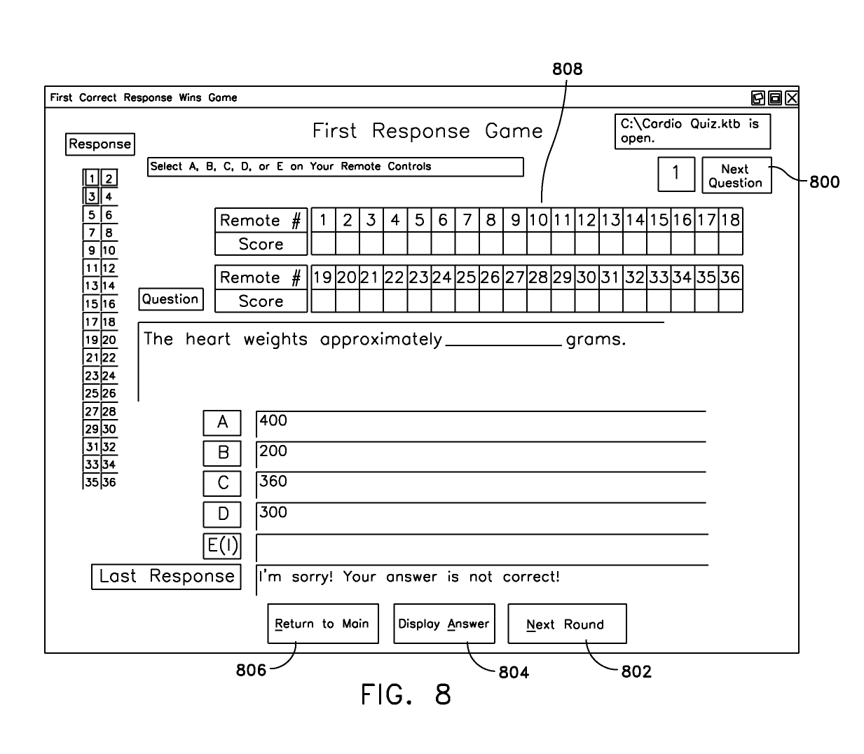

Referring again to the Main Menu screen of Testing Program 116 shown in FIG. 7A, another available option is the First Response Game 703. After launching the First Response Game mode, the user selects a question file (e.g., C:\Cardio Quiz.ktb) for execution in this mode. This question file includes the questions for the game. The game then begins. FIG. 8 shows a sample question screen shown to the audience in First Response Game Mode. The rules of the game are as follows. When a question appears on the screen, the first person to send a response locks all other participants out, at least temporarily. If that person's response is correct, he or she is awarded one point, and the presenter moves on to the next question by selecting the “next question” button 800. If the answer is incorrect, the presenter starts a “new round” on the same question by selecting the “next round” button 802, unlocking the other controllers and giving another person a chance to be the first responder. The original first responder is, however, locked out. This continues until a correct response is received, or until the presenter selects “display answer” button 804, “return to main” button 806 or “next question” button 800.

The software tracks the total number of rounds won by each user and thus updates this display after each question in grid area 808 keeps. Since no rounds are indicated as having been won, it is clear that FIG. 8 displays the first question from a game.

Per the foregoing, the software and system allow the audience to interact directly with the presentation via remote response units 130. This added functionality provides presenters with the ability to engage their audience directly with the presentation. The software can interface with POWERPOINT® software, or other presentations software products or be an independent, stand-alone software application in embodiments. In embodiments, the data transferred via the receiver to the computer are captured and processed by the Response Session Screen Generator Program 115, which is called by interactive buttons created using Plug-In Interactive Display Creator software 114 installed as an additional feature (i.e., “plug-in”) to the POWERPOINT® presentation software. The data received from the remote response units 130 are accessible to the Response Session Screen Generator Program 115 and provide the ability to capture, analyze and report the data. The data can be manipulated to provide answers to questions, analysis of results and game-type interactions. Stand-alone software is contemplated in case POWERPOINT®, or other presentation software, is not available.

Examples of various hardware components, such as the computer processor, remote units, data storage and the like are described in U.S. Pat. No. 6,895,213, the entirety of which is hereby incorporated by reference herein.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A method of presenting an interactive presentation on a display to an audience, comprising the steps of:
displaying a slide from a presentation to the audience with a presentation software application, said slide including a selectable element for initiating an audience response session;
upon selection of the selectable element, initiating the audience response session, wherein said initiating step comprises calling a response session screen generator program and passing at least one data element to said response session screen generator program; and
during the audience response session, displaying a question to said audience and receiving responses to said question from a plurality of remote response units distributed to the audience.

2. The method of claim 1, wherein the question is stored in a data storage and said data element comprises an identifier for the question, wherein said response session screen generator program obtains said question from said data storage and displays a graphical interface on said display presenting said question to the audience.

3. The method of claim 1, wherein:
said presentation software application displays said question in said slide to said audience, and
said data element comprises a correct answer to said question.

4. The method of claim 3, wherein said response session screen generator program displays a graphical interface over said slide, said graphical interface visually representing the receipt of responses to said question from said remote response units.

5. The method of claim 1, wherein said response session screen generator program displays a graphical interface on the display that visually represents the receipt of responses to said question from said remote response units.

6. The method of claim 5, wherein said graphical interface represents whether responses have been received from respective remote response units during said audience response session.

7. The method of claim 6, wherein said graphical interface represents whether responses have been received in a grid having respective locations corresponding to respective remote response units.

8. The method of claim 5, further comprising the step of receiving through said graphical interface a command to display a correct response to said question and, in response to said command, displaying the correct response in the graphical interface.

9. The method of claim 5, further comprising the step of receiving through said graphical interface during said audience response session a command to stop accepting responses to said question.

10. The method of claim 1, further comprising the step of receiving during said audience response session a command to stop accepting responses to said question.

11. The method of claim 10, further comprising the step of, after receiving said stop command, receiving a command to display a correct response to said question and displaying the correct response to the question on said display.

12. The method of claim 10, further comprising the step of, after receiving said stop command, receiving a command to display responses received from said remote response units and displaying the responses received from said remote response units on said display.

13. The method of claim 10, further comprising the step of, after receiving said stop command, receiving a command to display response statistics for responses received from said remote response units and displaying the response statistics on said display.

14. The method of claim 1, wherein said selectable element includes embedded code for calling said response session screen generator program and providing said data element to said response session screen generator program.

15. A method of preparing an interactive presentation for display to an audience on a display, comprising the steps of:
selecting a slide within an electronic presentation, said electronic presentation having a file format associated with a presentation software application; and
inserting a selectable element into said selected slide, wherein upon selection of said selectable element at least one data element is provided to a response session screen generator program to initiate an audience response session for receiving responses to a question from a plurality of remote response units.

16. The method of claim 15, wherein the data element comprises an identifier for a question in a data storage and said response session screen generator program displays a graphical interface on said display presenting said question to the audience.

17. The method of claim 15, wherein:
said slide contains a question for said audience, and
said data element comprises a correct answer to said question.

18. The method of claim 15, wherein said selectable element includes embedded code for calling said response session screen generator program and providing said data element to said response session screen generator program.

19. A system for presenting an interactive presentation on a display to an audience, comprising:
a plurality of remote response units;
a display; and
a computer processor comprising:
a presentation software application for displaying a presentation to the audience; and
a response session screen generator program, wherein upon selection of a selectable element included in a slide from said presentation said response session screen generator program receives at least one data element associated with said selectable element and initiates an audience response session, and said response session screen generator receives responses from said plurality of remote response units during said audience response session to a question displayed to said audience.

20. The system of claim 19, wherein the question is stored in a data storage and said data element comprises an identifier for the question, wherein said response session screen generator program obtains said question from said data storage and displays a graphical interface on said display presenting said question to the audience.

21. The system of method of claim 19, wherein:
said presentation software application displays said question in said slide to said audience, and
said data element comprises a correct answer to said question.

22. The system of claim 21, wherein said response session screen generator program displays a graphical interface over said slide, said graphical interface visually representing the receipt of responses to said question from said remote response units.

23. The system of claim 19, wherein said response session screen generator program displays a graphical interface on the display that visually represents the receipt of responses to said question from said remote response units.

24. The system 23, wherein said graphical interface represents whether responses have been received in a grid having respective locations corresponding to respective remote response units.

25. The system of 23, wherein said response session screen generator is configured to receive through said graphical interface a command to display a correct response to said question and, in response to said command, display the correct response in the graphical interface.

26. The system of claim 23, wherein said response session screen generator program is configured to receive through said graphical interface displayed during said audience response session a command to stop accepting responses to said question.

27. The system of claim 19, wherein said remote response screen generator program is configured to receive during said audience response session a command to stop accepting responses to said question.

28. The system of claim 21, wherein said remote response screen generator program is configured to, after receiving said stop command, receive a command to display a correct response to said question and to display the correct response to the question on said display.

29. The system of claim 27, wherein said remote response screen generator program is configured to, after receiving said stop command, receive a command to display responses received from said remote response units and display the responses received from said remote response units on said display.

30. The system of claim 27, wherein said remote response screen generator is configured to, after receiving said command, receive a command to display response statistics for responses received from said remote response units and display the response statistics on said display.

31. The system of claim 19, wherein said selectable element includes embedded code for calling said response session screen generator program and providing said data element to said response session screen generator program.

32. An apparatus for preparing an interactive presentation for display to an audience on a display, comprising:
means for selecting a slide within an electronic presentation, said electronic presentation having a file format associated with a presentation software application; and
means for inserting a selectable element into said selected slide, wherein upon selection of said selectable element at least one data element is provided to a response session screen generator program to initiate an audience response session for receiving responses to a question from a plurality of remote response units.

33. The system of claim 32, wherein the data element comprises an identifier for a question in a data storage and said response session screen generator program displays a graphical interface on said display presenting said question to the audience.

34. The system of claim 32, wherein:
said slide contains a question for said audience, and
said data element comprises a correct answer to said question.

35. The system of claim 32, wherein said selectable element includes embedded code for calling said response session screen generator program and providing said data element to said response session screen generator program.
